(19) United States
(12) Patent Application Publication
(10) Pub. No.: US 2010/0116831 A1
(43) Pub. Date: May 13, 2010

(54) Thermal Medicine Traveler

(76) Inventor: Hallie M. Delaney, Covington, LA (US)

Correspondence Address: nolaIP, LLC, P.O. BOX 24100, NEW ORLEANS, LA, 70184, US

(21) Appl. No.: 12/269,004

(22) Filed: Nov. 11, 2008

(51) Int. Cl. B65D 81/38; A61J 1/16

(52) U.S. Cl. 220/592.22; 206/438

(57) ABSTRACT

The present invention is a thermal medicine traveler, consisting of a durable outer shell, a soft inner lining, as well as a temperature controlling insert. The traveler is also designed to be compact, washable and easily transported.

### BACKGROUND OF THE INVENTION

The present invention relates to an apparatus that can be used to transport and control the temperature of medicine in a convenient and cost-effective manner.

In the traditional mode of transporting medicine, medicine bottles, especially those that are of a breakable nature, run the risk of being damaged in transport. This is especially prevalent when parents of young children carry around medicines for those children that need to be dispensed at particular times, so the medicines must be transported frequently, and across greater distances.

Further, medicines which are required to be cooled, such as antibiotics, are difficult to effectively transport, for fear that the medicine will spoil from not being kept at a specific temperature. Failure to keep them at this specified temperature may result in an ineffective battery of treatment, in turn resulting in a continuing sickness or repeated medicine regimen requirement.

In the current state of the art, bottles can be carried, but they run the risk of breakage, damage, and/or spoilage. The use of an ice chest can be employed, but this results in an additional large object being transported, which is both inconvenient and messy due to the quantities of ice required.

Obvious downsides to the current mode of transporting medicine exist, such as the inability to secure and control the temperature of medicines required during travel, as well as an inexpensive and convenient mode of storing these medicines.

The consequence of these issues is either not being able to transport the medicines, breakage of the medicine bottles, or spoilage of the medicine transported when refrigeration is not available.

The present invention of a thermal medicine traveler is thus a much-improved apparatus for transporting medicine, as it addresses all these concerns. A shielded device is disclosed, as well as a thermally controlled environment provided, for people in need of transporting medicines safely.

All of these aspects of the current mode of transporting medicine lead to an increased need for a revised apparatus for transporting medicine with minimized cost and complexity, all of which the present invention addresses.

### OBJECTS OF THE INVENTION

One object of the invention is to provide a convenient way to transport medicine.

Another object of this invention is to provide an economical way to transport medicine.

Yet another object of this invention is to provide an apparatus for transporting medicine that can control temperature.

Still another object of this invention is to provide an apparatus for transporting medicine that has a small footprint.

Other objects and advantages of this invention shall become apparent from the ensuing descriptions of the invention.

### SUMMARY OF THE INVENTION

According to the present invention, a thermal medicine traveler is disclosed, consisting of a durable outer shell, a soft inner lining, as well as a temperature controlling insert. The traveler is also designed to be compact, washable and easily transported.

### BRIEF DESCRIPTION OF THE DRAWINGS

The accompanying drawings and figures illustrate an embodiment of this invention. However, it is to be understood that this embodiment is intended to be neither exhaustive, nor limiting of the invention. They are but examples of some of the forms in which the invention may be practiced.

FIG. 1 is a perspective view of the thermal medicine traveler.

FIG. 2 is a perspective view of the thermal medicine traveler embodiment with removable inserts.

FIG. 3 is a cutaway view of the thermal medicine traveler.

### DETAILED DESCRIPTION OF EXEMPLARY EMBODIMENTS

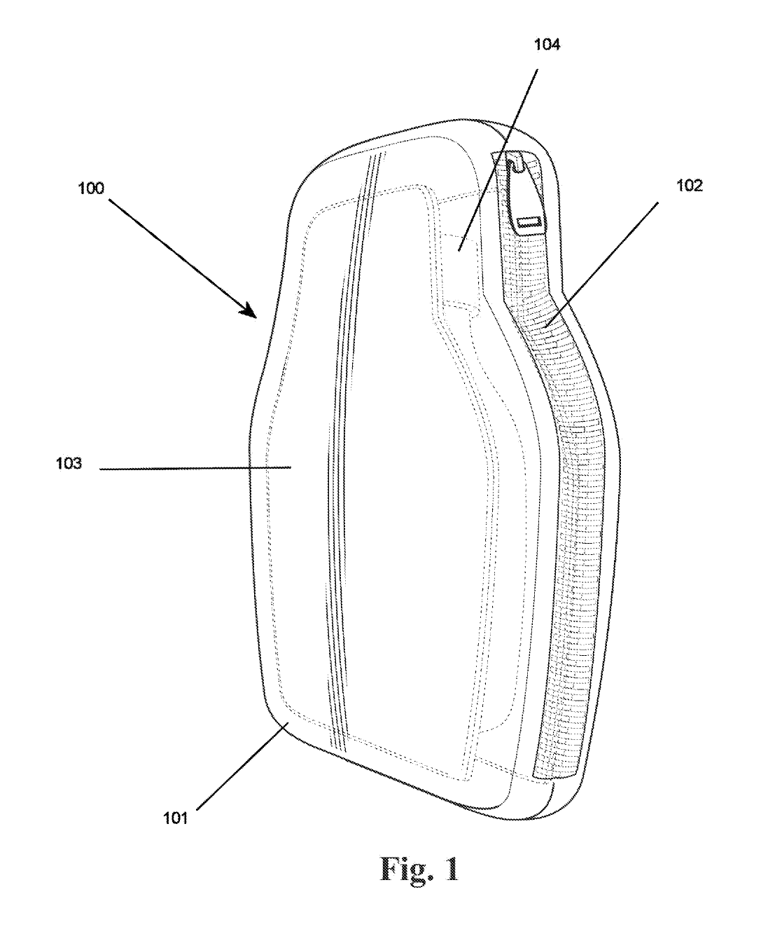

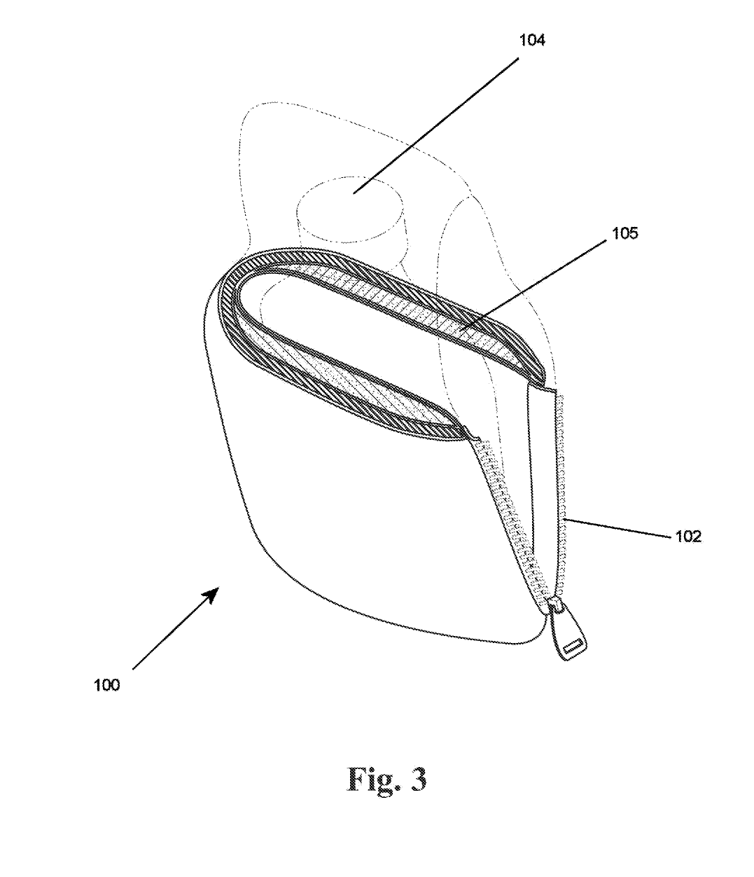

Without any intent to limit the scope of this invention, reference is made to the figures in describing the various embodiments of the invention. FIGS. 1 through 3 depict various aspects of exemplary embodiments of the present invention.

The present invention relates to a thermal medicine traveler 100 designed to transport bottles of medicine while also keeping the temperature somewhat constant for short periods of time.

The primary components of medicine traveler 100 are outer shell 101 which is designed and sized to fit a medicine bottle inside. Outer shell 101 can be made of many different materials, but in an ideal embodiment would be made of a material like neoprene, which is durable, washable and has insulating properties. Attached to outer shell 101 on its inner side is inner lining 106, typically a soft material which will not damage medicine bottle 104 therein, and aids in cushioning the bottle being transported therein.

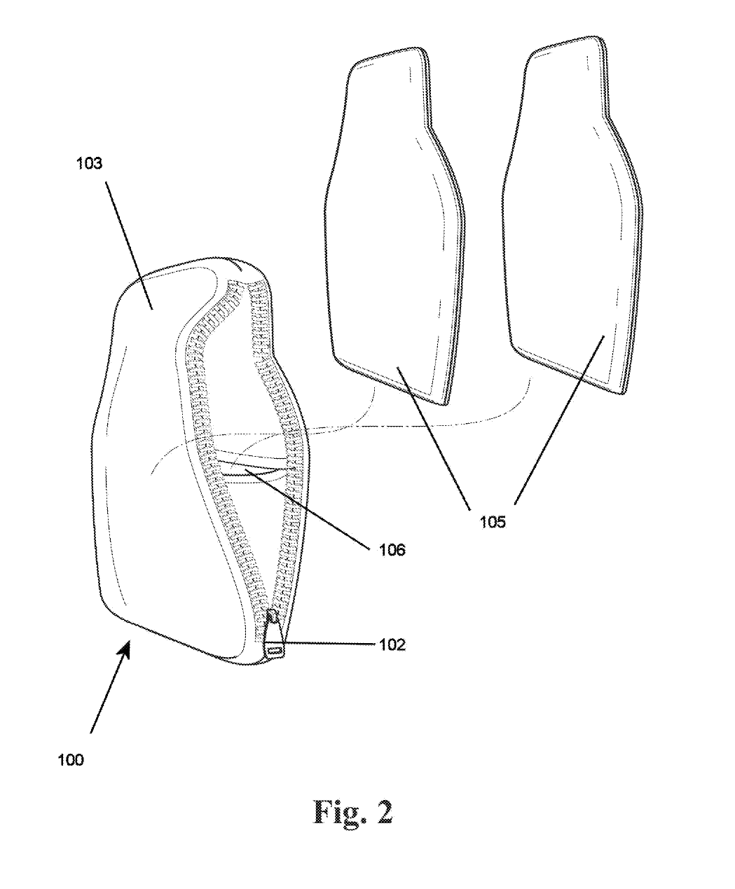

Disposed between outer shell 101 and inner lining 106 is thermal control insert 103, which is a material designed to retain the temperature of objects in close proximity thereto. Thermal control insert 103 can either be a permanently attached insert as in FIG. 1 or a removable insert as in FIG. 2. In either case, thermal control insert 103 can be of the same material, such as a thermal gel or a similar substance.

To keep outer shell 101 and inner lining 106 together, the exemplary embodiment in the figures is sewn along the majority of the perimeter, and utilizes closure device 102 to enable the opening and closing of the remaining portion of the perimeter of outer shell 101. Closure device 102 can be a zipper as pictured in the Figures, or any number of other types of closures.

In operation, then, closure device 102 is opened, medicine bottle 104 is inserted therein, and closure device 102 is closed to secure and contain medicine bottle 104. These steps are reversed to remove the bottle.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A thermal medicine bottle traveler comprising:
a. an outer shell shaped to form a pouch of a size sufficient to receive a medicine bottle having an outer side and an inner side;
b. an inner lining configured to be placed within said outer shell and operatively attached to said inner side of said outer shell;
c. a thermal control insert disposed between said outer shell and said inner shell; and
d. a closure device operatively attached to said outer shell such that operating said closure device reveals and conceals said pouch.

2. The thermal medicine bottle traveler of claim 1 wherein said closure device is a zipper.

3. The thermal medicine bottle traveler of claim 1 wherein said thermal control insert is a gel pack.

4. The thermal medicine bottle traveler of claim 3 wherein said gel pack is removable from said outer shell.
